(19) United States
(12) Patent Application Publication
(10) Pub. No.: US 2013/0028799 A1
(43) Pub. Date: Jan. 31, 2013

(54) REACTOR VESSELS HAVING LIQUID DRAIN PIPES AND METHODS FOR DRAINING LIQUID FROM REACTOR INTERNALS

(71) Applicants: Zhanping Xu, Inverness, IL (US); Pengfei Chen, Des Plaines, IL (US)

(72) Inventors: Zhanping Xu, Inverness, IL (US); Pengfei Chen, Des Plaines, IL (US)

(73) Assignee: UOP LLC, Des Plaines, IL (US)

(21) Appl. No.: 13/191,319

(22) Filed: Jul. 26, 2011

(51) Int. Cl. B01J 19/00; B23P 11/00; F17D 1/00; B01D 3/22

(52) U.S. Cl. 422/129; 261/114.5; 137/15.01; 137/1

(57) ABSTRACT

Embodiments of vessels including liquid drain pipes are provided, as are embodiments of methods for draining liquid from reactor internals. In one embodiment, the vessel includes a vessel shell, a tray mounted within the vessel shell and over which liquid accumulates up to a maximum liquid level during vessel operation, and a liquid drain pipe. The liquid drain pipe includes a tubular body attached to the tray and projecting upward therefrom, a vapor inlet formed in the tubular body above the maximum liquid level, a liquid inlet formed in the tubular body between the maximum liquid level and the tray, and a drainage port formed in the tubular body and positioned to direct accumulated liquid above the tray to an area below the tray to permit the drainage of accumulated liquid from over the tray during vessel shutdown.

### FIELD OF THE INVENTION

The present invention relates generally to vessel internals including liquid drain pipes, as well as to methods for draining liquid from reactor vessel internals.

### DESCRIPTION OF RELATED ART

Reactor vessels are often equipped with one or more vapor-liquid distribution trays, which are disposed within the vessel shell above a catalyst bed. Each vapor-liquid distribution tray commonly includes a generally cylindrical flat disk sealingly mounted within the vessel shell and commonly referred to as a “tray plate.” In larger vessels, the tray plate may be assembled from multiple pieces or panels, which are attached to a support structure (e.g., supports rings welded to the vessel wall in combination with beams running across the vessel cross-section) utilizing a plurality of fasteners (e.g., J-clips or clamps). To enable the flow of liquid and vapor across the distribution tray, a plurality of vapor-liquid distribution units extend through the tray plate. While various different types of vapor-liquid distribution units are known, in one common design, each vapor-liquid distribution unit includes at least one inlet for vapor entry and a plurality of inlets for liquid entry. The inlet for vapor entry may assume the form of an opening provided in the upper terminal end of the distribution unit. The inlets for liquid entry may assume the form of a plurality of ports provided through a sidewall of the distribution unit at varying heights with respect to the upper surface of the tray plate. During operation of the reactor vessel, liquid and vapor flow concurrently downward through the distribution units to the catalyst bed underlying the tray plate to provide substantially uniform distribution of liquid and vapor over the catalyst bed.

To prevent clogging by debris, a vertical standoff or separation is commonly provided between the lowest liquid inlet provided in a given distribution unit and the tray plate; e.g., as one example, the lowest liquid inlet may be positioned approximately 50 millimeters (2 inches) above the upper surface of the tray plate. As the tray plate is sealingly mounted within the reactor vessel, liquid accumulates or pools below the lowest liquid inlet provided in the distributor. While acceptable during operation of the reactor vessel, pooling of liquid over the tray plate renders inspection and maintenance of vapor-liquid distribution tray and other components of the reaction vessel difficult when the reactor vessel is shutdown. Perforations or through-holes can be formed through the tray plate to allow drainage of liquid from over the vapor-liquid distributor tray during reactor vessel shutdown; however, the provision of such through-holes allows undesired amount of liquid leakage across the vapor-liquid tray during reactor vessel operation thereby contributing to large maldistrubtion of liquid over the catalyst bed. Liquid leakage across through-openings in the tray plate is especially problematic in instances wherein a considerable pressure drop develops across the vapor-liquid distribution tray during operation of the reactor vessel.

It would thus be desirable to provide embodiments of a reactor vessel including a liquid drainage means enabling drainage of liquid from over a vapor-liquid distribution tray (or other such tray) during reactor vessel shutdown, while minimizing liquid leakage across the distribution tray during reactor vessel operation. Ideally, embodiments of such a liquid drainage means would be relatively inexpensive to produce and would operate in a reliable manner. It would also be desirable to provide embodiments of a method for draining liquid from a vapor-liquid distribution tray and other reactor internals during shutdown of a reactor vessel. Other desirable features and characteristics of embodiments of the present invention will become apparent from the subsequent Detailed Description and the appended Claims, taken in conjunction with the accompanying Drawings and the foregoing Description of Related Art.

### SUMMARY OF THE INVENTION

Embodiments of vessels including liquid drain pipes are provided. In one embodiment, the vessel includes a vessel shell, a tray mounted within the vessel shell and over which liquid accumulates up to a maximum liquid level during vessel operation, and a liquid drain pipe. The liquid drain pipe includes a tubular body attached to the tray and projecting upward therefrom, a vapor inlet formed in the tubular body above the maximum liquid level, a liquid inlet formed in the tubular body between the maximum liquid level and the tray, and a drainage port formed in the tubular body and positioned to direct accumulated liquid above the tray to an area below the tray to permit the drainage of accumulated liquid from over the tray during vessel shutdown.

Embodiments of a method for the manufacture of a vessel including a vessel shell and a vapor-liquid distribution tray are further provided. The vapor-liquid distribution tray includes a tray plate mounted within the vessel shell and over which liquid accumulates to a maximum liquid level during vessel operation. In one embodiment, the method includes the steps of providing a liquid drain pipe including: (i) a tubular body having an upper end portion and a lower end portion; (ii) a vapor inlet formed in the upper end portion of the tubular body; (iii) a liquid inlet formed in the tubular body between the upper end portion and the lower end portion; and (iv) a drainage port formed in the lower end portion of the tubular body. The method further includes the step of mounting the liquid drain pipe to the tray plate of the vapor-liquid distribution tray such that the vapor inlet is positioned above the maximum liquid level, the liquid inlet is positioned below the maximum liquid level and at or above the tray plate, and the drainage port is positioned below the upper surface of the tray plate to direct liquid accumulated above the tray plate to an area below the tray plate to drain accumulated liquid from over the vapor-liquid distribution tray during vessel shutdown.

Embodiments of a method for draining liquid from over a vapor-liquid distribution tray are still further provided. The vapor-liquid distribution tray includes a tray plate mounted within the vessel shell of a vessel and over which liquid accumulates to a maximum liquid level during vessel operation. In one embodiment, the method includes the step of providing the vapor-liquid distribution tray with at least one liquid drain pipe including: (i) a tubular body having an upper end portion and a lower end portion; (ii) a vapor inlet formed in the upper end portion of the tubular body; (iii) a liquid inlet formed in the tubular body between the upper end portion and the lower end portion; and (iv) a drainage port formed in the lower end portion of the tubular body. The method further includes the step of directing liquid into the liquid drain pipe through the liquid inlet, through the tubular body, and out of the drainage port during vessel shutdown to drain accumulated liquid from over the vapor-liquid distribution tray.

### BRIEF DESCRIPTION OF THE DRAWINGS

The present invention will hereinafter be described in conjunction with the following drawing figures, wherein like numerals denote like elements, and wherein:

FIG. 1 is a schematic of a simplified reactor vessel in which one or more drain pipes may be deployed in accordance with an exemplary embodiment of the present invention;

FIG. 2 is a top-down view of a portion of a tray plate included within the reactor vessel shown in FIG. 1 and including a plurality of distribution units and a plurality of liquid drain pipes mounted therethrough;

FIG. 3 is a cross-sectional view of a distribution unit and a liquid drain pipe shown in FIG. 2 illustrating an exemplary embodiment of the liquid drain pipe in greater detail; and

FIGS. 4 and 5 are models of liquid volume fraction and pressure contours, respectively, demonstrating the performance of an exemplary embodiment of the liquid drain pipe as compared to a through-hole provided in a tray plate.

### DETAILED DESCRIPTION

The following Detailed Description is merely exemplary in nature and is not intended to limit the invention or the application and uses of the invention. Furthermore, there is no intention to be bound by any theory presented in the preceding Description of Related Art or the following Detailed Description.

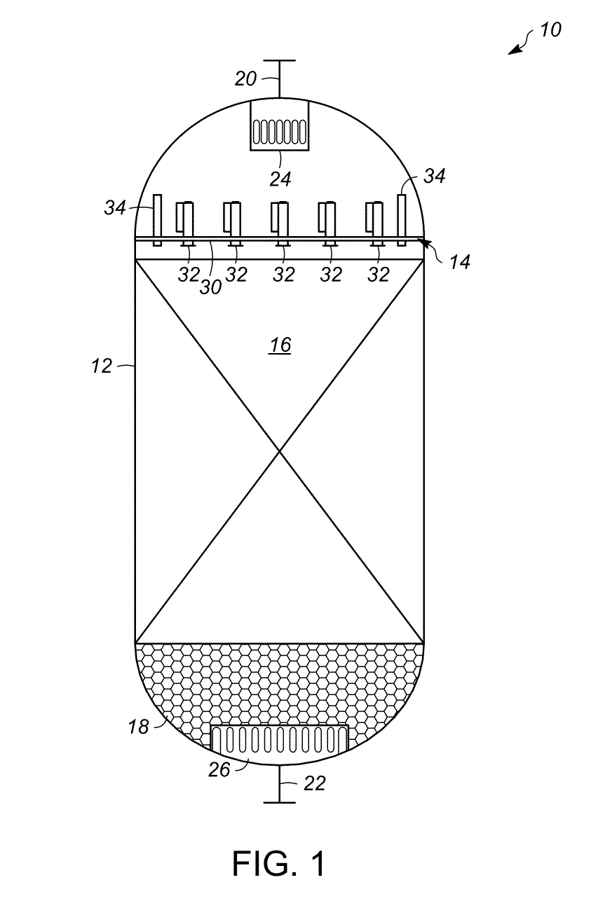

FIG. 1 is a schematic of a simplified reactor vessel 10 illustrated in accordance with an exemplary embodiment of the present invention. In this particular example, reactor vessel 10 assumes the form of a relatively simple reactor having a single catalyst bed; however, it is emphasized that reactor vessel 10 is provided by way of example only and that embodiments of the reactor vessel described herein can assume any form including at least one tray or other partitioning member across which vapor and liquid are conducted during reactor vessel operation and over which liquid may pool, temporarily or permanently, during reactor vessel shutdown. In most embodiments, the tray will assume the form of a vapor-liquid distribution tray utilized to distribute vapor and liquid to an underlying catalyst bed. For the sake of completeness, it is noted that reactor vessel 10 and similar reactor vessels are commonly utilized to carry-out hydroprocessing reactions; however, it is emphasized that embodiments of reactor vessel 10, and more specifically embodiments of the liquid drain pipes described herein below, can be utilized in conjunction with a wide variety of reactor internals where liquid cannot be adequately drained during reactor shutdown and reaction vessels wherein at least one catalyst bed is contacted with downward flowing liquid and vapor phases regardless of the particular reaction carried-out utilizing the reaction vessel.

In the illustrated example (not drawn to scale), reactor vessel 10 includes a vertically-oriented vessel shell 12, a vapor-liquid distribution tray 14 mounted within shell 12, and a catalyst bed 16 disposed within shell 12 below distribution tray 14. Catalyst bed 16 may rest on an inert support material 18 (shown in FIG. 1), a support grid, or other support structure. A liquid/vapor inlet 20 (e.g., a first nozzle) is provided through the upper end of vessel shell 12, and a liquid/vapor outlet 22 (e.g., a second nozzle) is provided through the lower end of vessel shell 12. During operation of reactor vessel 10, liquid and vapor are supplied to reactor vessel 10 through liquid/vapor inlet 20. As the liquid and vapor may enter reactor vessel 10 as a high velocity stream, an inlet diffuser 24 is further provided within reactor vessel 10 below inlet 20 to prevent direct impingement of the stream on the vapor-liquid distribution tray 14. If desired, a pre-distribution tray may be installed between inlet diffuser 24 and the vapor-liquid distribution tray 14. Vapor-liquid distribution tray 14 distributes the liquid and vapor received from diffuser 24 over catalyst bed in a substantially uniform manner; that is, such that flow rate of the liquid and vapor phases are substantially uniform across the reactor vessel cross-section immediately above catalyst bed 16. After flowing through catalyst bed 16, the liquid and vapor is collected within a collector 26 and ultimately withdrawn from reactor vessel 10 through liquid/vapor outlet 22. In further embodiments, reactor vessel 10 may include additional catalyst beds (e.g., two or more catalyst beds positioned in series above catalyst bed 16 and suspended by support grids or other suitable support structures), additional vapor-liquid distribution trays positioned above any additional catalyst beds, and various other components and features (e.g., quench stream inlets), as conventionally-known in hydrocarbon processing and other chemical processing industries.

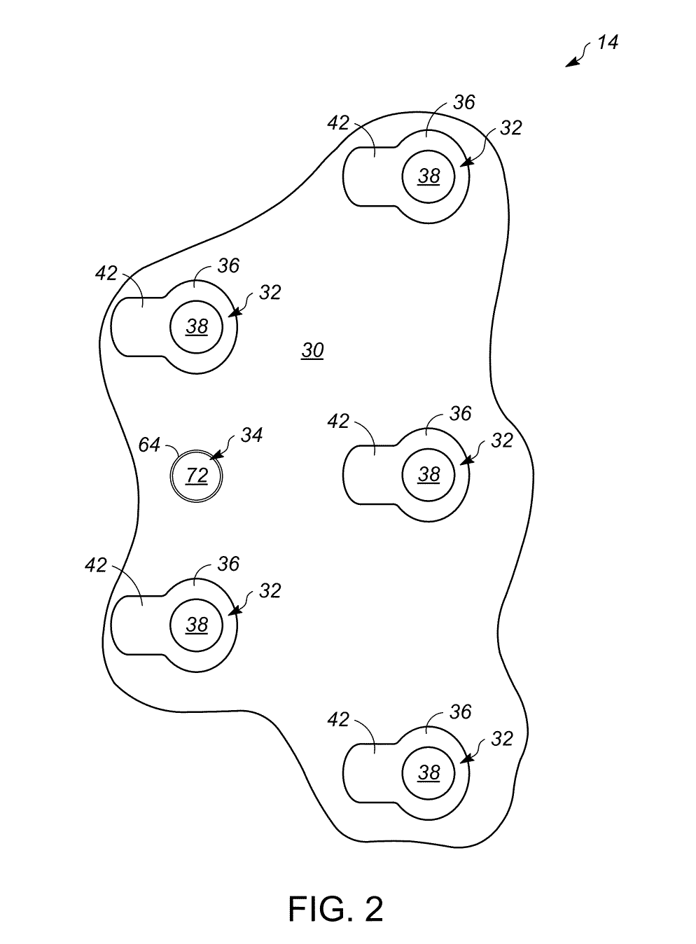

FIG. 2 is a top down view of a portion of vapor-liquid distribution tray 14 illustrated in accordance with an exemplary embodiment of the present invention. As can be seen in FIG. 2, vapor-liquid distribution tray 14 includes tray plate 30 and a plurality of distribution units 32, which are mounted through tray plate 30. A plurality of liquid drain pipes 34 is likewise mounted through tray plate 30 (only one of which is shown in FIG. 2) and interspersed with distribution units 32. More specifically, the illustrated portion of vapor-liquid distribution tray 14 includes five distribution units 32, which are interspersed with a single liquid drain pipe 34 in a grid-type pattern; however, it will be appreciated that a lesser or greater number of distribution units can be combined with a lesser or greater number of liquid drain pipes in various other types of spatial arrangements. For example, although generically shown in FIG. 1 as positioned around the outer perimeter of tray plate 30, one or more of drain pipes 34 may be disposed through a central portion of tray plate 30. In general, the number of liquid drain pipes 34 included within reactor vessel 10 will be significantly less than the number of distribution units 32; e.g., the ratio of the drain pipes to distribution units can be roughly in the range of 1:10 to 1:100.

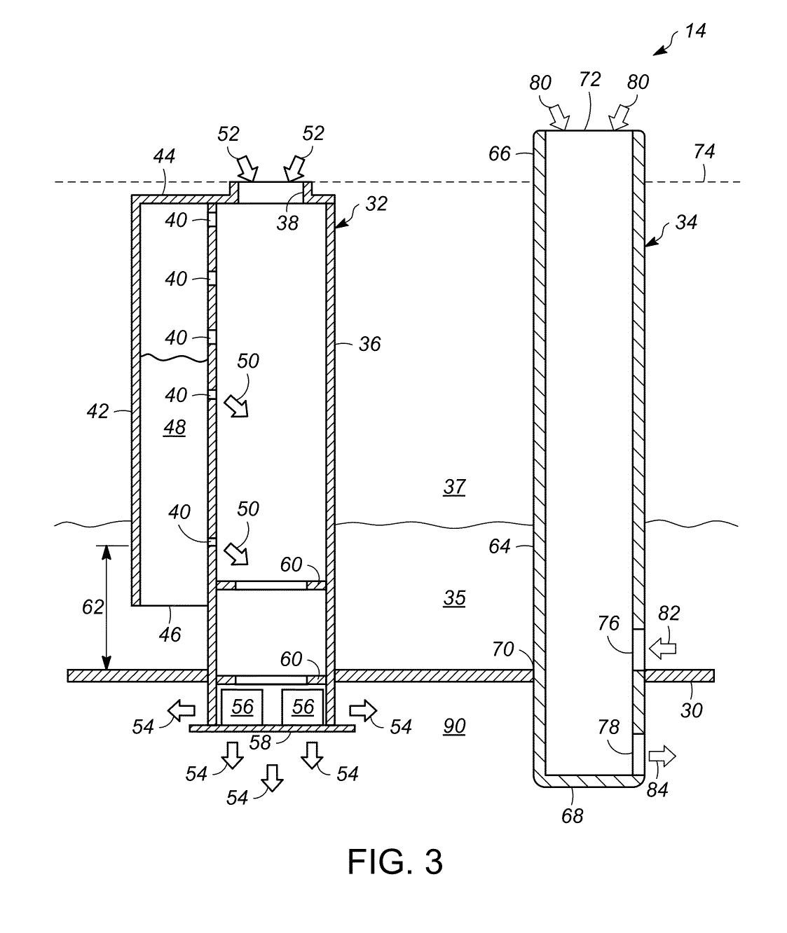

FIG. 3 is a cross-sectional view of a portion of vapor-liquid distribution tray 14 illustrating a distribution unit 32 and a liquid drain pipe 34 in greater detail. FIG. 3 illustrates distribution unit 32 and liquid drain pipe 34 during reactor unit operation; consequently, the liquid injected into reactor vessel 10 through overhead inlet 20 (FIG. 1) has accumulated over tray plate 30 as a body or pool 35, and vapor phases 37 have collected over liquid pool 35. As previously noted, the distribution unit 32 shown in FIG. 3, along with the other distribution units included within vapor-liquid distribution tray 14, serve as conduits for supplying the vapor and liquid phases to the underlying catalyst bed (e.g., catalyst bed 16 shown in FIG. 1) in a substantially uniform manner. Distribution unit 32 can assume any form and may include any number and arrangement of structural elements suitable for performing this function. For example, in certain embodiments, distribution 32 may be a chimney-type or bubble cap-type distribution unit. In the embodiment illustrated in FIG. 3, and by way of non-limiting example only, distribution unit 32 is depicted as a liquid seal distribution unit of the type described in U.S. Pat. No. 7,506,861 B2, entitled “DISTRIBUTION DEVICE FOR TWO-PHASE CONCURRENT DOWNFLOW VESSELS,” issued Mar. 24, 2009, to Müller.

In the exemplary embodiment illustrated in FIGS. 2 and 3, distribution unit 32 includes a downcomer pipe 36, which is mounted through tray plate 30 and which projects upwardly therefrom. A vapor inlet 38 is provided in the uppermost end of downcomer pipe 36 and assumes the form of an opening normal to the longitudinal axis of pipe 36. A plurality of liquid inlets or ports 40 is provided through the annular sidewall of downcomer pipe 36 with each liquid inlet 40 positioned at a different height with respect to the upper surface of tray plate 30. A liquid intake conduit 42 is joined to a sidewall of downcomer pipe 36 to enclose liquid sidewall ports 40. Liquid intake conduit 42 assumes the form of a blind tube or pipe segment having a closed upper end 44 and an open lower end 46, which is vertically spaced from tray plate 30 to permit the inflow of liquid pool 35. Liquid intake conduit 42 is thus positioned adjacent to and extends in parallel with downcomer pipe 36.

During operation of reactor vessel 10 (FIG. 1), liquid from pool 35 enters open lower end 46 of liquid intake conduit 42 to form a liquid column 48. As pressure drop is created within downcomer pipe 36, the height of liquid column 48 will generally be greater than the height of liquid pool 35. As indicated in FIG. 3 by arrows 50, the liquid sidewall ports 40 having a height less than the height of liquid column 48 allow the inflow of liquid into downcomer pipe 36. Concurrently, and as indicated in FIG. 3 by arrows 52, vapor inlet 38 allows the entry of vapor into downcomer pipe 36. The vapor and liquid flow co-currently downward within downcomer pipe 36, across tray plate 30, and ultimately exit downcomer pipe 36 through one or more outlets provided beneath tray plate 30 (indicated in FIG. 3 by arrows 54). In the illustrated example, the outlets of downcomer pipe 36 include a plurality of sidewall openings 56 circumferentially spaced around the lower end of pipe 36 (only two of which can be seen in FIG. 3) and a plurality of through-holes provided through a perforated plate 58 affixed to the lower end of pipe 36. If desired, distribution unit 32 can further be equipped with one or more flow regulating structures or devices, such as one or more orifice plates 60.

In conventional distribution unit designs, and as indicated in FIG. 3 by double-headed arrow 62, a vertical standoff or separation is provided between tray plate 30 and the lowest sidewall port or fluid inlet 40 to prevent clogging with debris carried by liquid pool 35; e.g., the lowest sidewall port 40 may be separated from the upper surface of tray plate 30 by a vertical distance of approximately 50 millimeters (2 inches). However, due to this vertical standoff, distribution unit 32 does not provide a flow path for drainage of liquid from over tray plate 30 below the lowest sidewall port 40. Consequently, if no other drainage conduit or path is provided and in embodiments wherein, and as a liquid-tight seal is generally formed between the outer circumferential edge of plate 30 and the inner circumferential surface of vessel shell 12, a standing pool of liquid will remain over tray plate 30 having a depth substantially equivalent to this vertical standoff. As noted in the foregoing section entitled “BACKGROUND,” one or more perforations or through-holes can be formed in tray plate 30 to allow drainage of standing liquid across vapor-liquid distribution tray 14 during reactor vessel shutdown. However, during reactor vessel operation, the provision of through-holes in tray plate 30 allow excessive liquid to leak across vapor-liquid distribution tray 14 and thereby negatively impact the desired liquid distribution to the underlying catalyst bed. Leakage across tray plate 30 is especially problematic under operating conditions wherein a high pressure drop occurs across vapor-liquid distribution tray 14 (FIG. 1) as the leakage of liquid is driven both by the height (or depth) of liquid pool 35 in combination with the pressure drop across tray plate 30 created by the down-flowing vapor 37 above pool 35. To address this limitation in conventional vapor-liquid distribution tray designs, reactor vessel 10 is further equipped with liquid drain pipes 34, which are mounted to and which may extend through distribution tray 14 to enable the drainage of liquid from over tray plate 30 during reactor vessel shutdown, while allowing minimal liquid leakage across distribution tray 14 during reactor vessel operation.

In the exemplary embodiment illustrated in FIG. 3, liquid drain pipe 34 includes a tubular body 64 having an upper end portion 66 and a lower end portion 68. As appearing herein, the term “tubular body” encompasses any elongated conduit suitable for conducting liquid and vapor across tray plate 30, regardless of the particular cross-sectional geometry of the conduit. Tubular body 64 is mounted through an opening 70 provided in tray plate 30 and projects upwardly therefrom such that upper end portion 66 is located above tray plate 30, while lower end portion 68 is located below tray plate 30. The longitudinal axis of tubular body 64 may be substantially parallel to the longitudinal axis of vessel shell 12 (FIG. 1) and substantially orthogonal to the upper surface of tray plate 30. A liquid-tight seal is created between the outer circumferential surface of tubular body 64 and the inner circumferential edge of tray plate 30 defining opening 70 by way of, for example, a circumferential weld joint. Alternatively, liquid drain pipe 34 can be sealingly attached to tray plate 30 via a threaded interface. While, in the exemplary embodiment illustrated in FIGS. 1-4, liquid drain pipe 34 has a substantially uniform or constant cross-sectional shape, it will be appreciated that the cross-sectional shape of tubular body 64 may vary along the longitudinal axis of pipe 34 in further embodiments; e.g., in certain implementations, an upper section of liquid drain pipe 34 may have a larger pipe diameter, while a lower section of pipe 34 has a smaller pipe diameter.

At least one vapor inlet 72 is provided in upper end portion 66 of liquid drain pipe 34. For example, as shown in FIG. 3, liquid drain pipe 34 may assume the form of a blind tube such that upper end portion 66 of tubular body 64 is open, while lower end portion 68 is closed (that is, enclosed by a terminal endwall). In this case, vapor inlet 72 may assume the form of the opening provided through open upper end portion 66 of liquid drain pipe 34 having an orientation substantially normal to the longitudinal axis of pipe 34. As a point of emphasis, vapor inlet 72 is located above the maximum liquid level of reactor vessel 10, as represented in FIG. 3 by dashed line 74; that is, the highest level to which liquid accumulates over tray plate 30 under all expected operational conditions of reactor vessel 10, possibly including a certain safety margin. The maximum liquid level will typically be considerably higher, as taken with respect to tray plate 30, than will the liquid level under normal operating conditions of reactor vessel 10. As indicated in FIG. 3, the maximum liquid level may be slightly below or substantially level with the upper ends of distribution units 32. By positioning vapor inlet 72 above the maximum liquid level, it can be ensured that liquid pool 35 will not inadvertently spill over and into vapor inlet 72 during reactor vessel operation.

Liquid drain pipe 34 further includes at least one liquid inlet 76, which is formed in tubular body 64 between the maximum liquid level and the upper surface of tray plate 30; and at least one drainage port 78, which is formed in tubular body 64 below the upper surface of tray plate 30 and, preferably, below tray plate 30. As shown in FIG. 3, liquid inlet 76 may assume the form of a port or opening formed through the annular sidewall of tubular body 64. To allow complete drainage of accumulated liquid from over tray plate 30, liquid inlet 76 is preferably formed adjacent the upper surface of tray plate 30. In the illustrated example wherein lower end portion 68 of liquid drain pipe 34 is enclosed and extends beyond the lower surface of tray plate 30 in a downward direction, drainage port 78 may likewise assume the form of a sidewall port formed through the annular sidewall of tubular body 64 and, in preferred embodiments, may be positioned so as to direct the liquid/vapor outflow stream in a substantially horizontal direction. In this manner, the impact of the liquid and vapor discharge from liquid drain pipe 34 on the underlying catalyst bed may be lessened to minimize catalyst bed disturbance.

During reactor vessel operation, and as indicated in FIG. 3 by arrows 80, vapor 37 enters tubular body 64 of liquid drain pipe 34 through vapor inlet 72. The pressure within liquid drain pipe 34 is close to the pressure outside of pipe 34 as vapor flow through the drain pipe is low, and the pressure drop of the vapor flow into the drain pipe is minimal. The inflow of liquid into liquid drain pipe 34 through liquid inlet 76 is driven by the pressure difference between inside and outside of the drain pipe in addition to the height of liquid pool 35. However, as the pressure within liquid drain pipe 34 is substantially equivalent to the pressure in the vapor space 37, the pressure drop across tray plate 30 is effectively eliminated as a driving force urging the inflow of liquid into pipe 34. Inflow of liquid into liquid inlet 76 is thus driven, solely or at least in its substantial entirety, by the height of liquid pool 35. Consequently, relatively little liquid from liquid pool 35 flows into liquid inlet 76 during reactor vessel operation and undesired leakage across vapor-liquid distribution tray 14 is minimized. During reactor vessel shutdown, liquid is freely permitted to flow into liquid drain pipe 34 through liquid inlet 76 (represented in FIG. 3 by arrow 82), downward within body 64 of pipe 34 across tray plate 30, and exit pipe 34 through sidewall drainage port 78 (represented in FIG. 3 by arrow 84) under the influence of gravitational forces. In this manner, liquid drain pipe 34 permits drainage of standing or pooled liquid from over vapor-liquid distribution tray 14 in the event of reactor vessel shutdown, while minimizing undesired liquid leakage across distribution tray 14 during reactor vessel operation.

Liquid drain pipe 34 may also be described as fluidly coupling high and low pressure vapor zones located above and below tray plate 30, respectively, with the terms “high” and “low” utilized in a relative sense and denoting a higher pressure zone and a lower pressure zone, respectively, created during operation of the reactor vessel. The high pressure zone is located above liquid pool 35 and corresponds to vapor cloud 37, while the low pressure zone is located between tray plate 30 and the underlying catalyst bed (identified in FIG. 3 by reference numeral 90). Liquid drain pipe 34 extends from the high pressure zone, through tray plate 30, and to the low pressure zone. Vapor inlet 72 is located within the high pressure zone, and drainage port 78 is located within the low pressure zone.

The number and dimensions of liquid drain pipe 34 will inevitably vary amongst different embodiments depending upon process conditions and the dimensions and disposition of tray plate 30, distribution units 32, and the various other components included within reactor vessel 10 (FIG. 1). However, by way of non-limiting example, in an embodiment wherein the liquid level is approximately 200 millimeters (7.875 inches) when expressed as a vertical distance from the upper surface of tray plate 30, the pressure differential across tray plate 30 is approximately 5000 pascal, the vapor density is approximately 28.83 kilograms per cubic meter (1.8 pounds per cubic foot), the liquid density is approximately 582.27 kilograms per cubic meter (36.35 pounds per cubic foot), the inner diameter of liquid drain pipe 34 and the diameter of vapor inlet 72 may each be approximately 50.8 millimeters (2 inches), and the diameters of sidewall liquid inlet 76 and drainage port 78 may each be approximately 12.7 millimeters (0.5 inch).

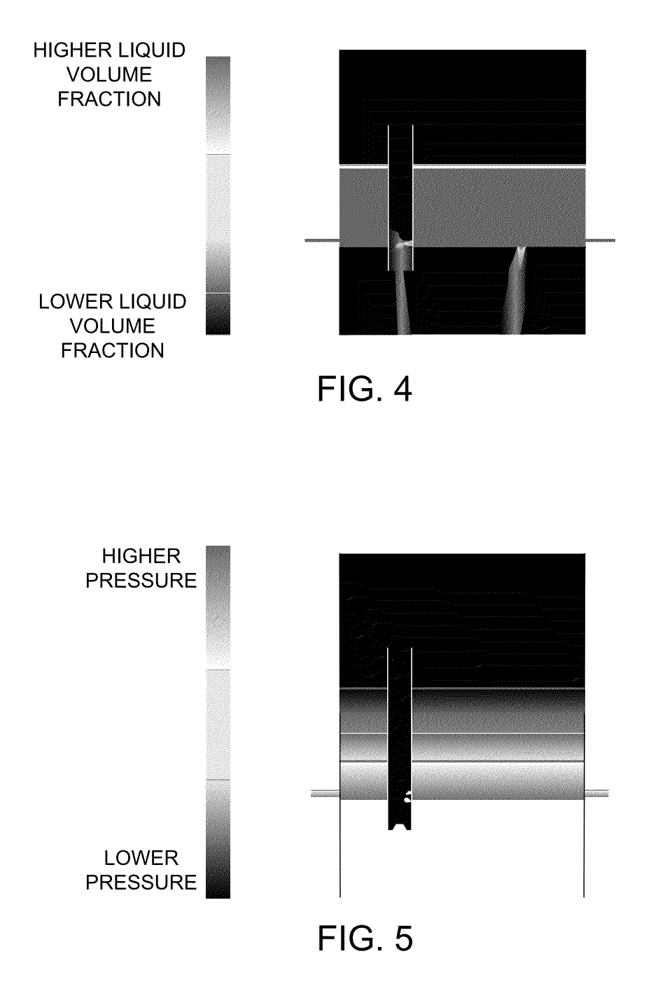

To further demonstrate the effectiveness of the liquid drain pipe, an embodiment of the liquid drain pipe having the above-noted dimensions was modeled under the process conditions set-forth above and at a liquid flow rate of approximately 29.3 liters per minute (7.75 gallons per minute). The resultant liquid volume fraction model is shown in FIG. 4, and the resultant pressure model is shown in FIG. 5 (visually expressed as contours of static pressure). The liquid drain pipe is shown on the left side in each of FIGS. 4 and 5 (note that, in this embodiment, the liquid drain port is formed through the lower end wall of the drain pipe), and a through-hole provided through the tray plate and also having a diameter of approximately 12.7 millimeters (0.5 inch) is shown on the right FIGS. 4 and 5 for comparison purposes. As may be appreciated from FIG. 5, the pressure drop through sidewall liquid inlet 76 (about 1140 Pa) is significantly less than the pressure drop through the neighboring through-hole (about 6140 Pa). As a result, the flow rate through the illustrated liquid drain pipe is significantly less than the flow rate through the neighboring through-hole; in particular, the flow rate through the drainage port of the drain pipe was determined to be approximately 0.085 kilograms per second, while the flow rate through the through-hole was determined to be approximately 0.20 kilograms per second. Thus, under the above-specified process conditions, flow rate through the liquid drain pipe was thus shown to be less than half the flow rate through a through-hole of comparable dimensions. As may further be appreciated from FIG. 5, the pressure within the liquid drain pipe was further shown to be substantially equivalent to the vapor pressure over the liquid pool under the above-described operating conditions.

The foregoing has thus provided embodiments of a reactor vessel including one or more liquid drain pipes that enable the drainage of liquid from a vapor-liquid distribution tray during reactor vessel shutdown, while restricting liquid leakage across the distribution tray to a minimum during reactor vessel operation. Notably, the embodiments of the above-described liquid drain pipe are relatively inexpensive to manufacture and operate in reliable manner. The foregoing has also provided embodiments of a method for draining liquid from a vapor-liquid distribution tray and other reactor internals during shutdown of a reactor vessel. In one embodiment, the method includes the step of providing a liquid drain pipe including at least one vapor inlet, at least one liquid inlet, and at least one drainage port, as described above; and the step of directing liquid into the liquid drain pipe through the liquid inlet, through the tubular body, and out of the drainage port during reactor vessel shutdown to drain accumulated liquid from over the vapor-liquid distribution tray. While described above in the context of an exemplary reactor vessel, it is emphasized that embodiments of the above-described liquid drain pipe can be utilized in conjunction with any type of vessel, including non-reactor vessels, containing downward-flowing liquid and vapor where liquid accumulates or pools over a tray plate or other structure during vessel shutdown.

The foregoing has further provided embodiments of a method for the manufacture of a reactor vessel including a vessel shell and a vapor-liquid distribution tray. In one embodiment, the method includes the step of providing a liquid drain pipe including at least one vapor inlet, at least one liquid inlet, and at least one drainage port, as described above; and the step of mounting the liquid drain pipe to the tray plate of a vapor-liquid distribution tray such that the vapor inlet is positioned above the maximum liquid level, the liquid inlet is positioned below the maximum liquid level and above the tray plate, and the drainage port is positioned below the upper surface of the tray plate to direct liquid accumulated above the tray plate to an area below the tray plate to drain accumulated liquid from over the vapor-liquid distribution tray during reactor vessel shutdown.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention, it being understood that various changes may be made in the function and arrangement of elements described in an exemplary embodiment without departing from the scope of the invention as set forth in the appended Claims and their legal equivalents.

What is claimed is:

1. A vessel, comprising:
a vessel shell;
a tray mounted within the vessel shell and over which liquid accumulates up to a maximum liquid level during vessel operation; and
a liquid drain pipe, comprising:
a tubular body attached to the tray and projecting upward therefrom;
a vapor inlet formed in the tubular body above the maximum liquid level;
a liquid inlet formed in the tubular body between the maximum liquid level and the tray; and
a drainage port formed in the tubular body and positioned to direct accumulated liquid above the tray to an area below the tray to permit the drainage of accumulated liquid from over the tray during vessel shutdown.

2. A vessel according to claim 1 wherein tubular body extends through the tray, and wherein the drainage port is located below the lower surface of tray.

3. A vessel according to claim 2 wherein the drainage port is formed through the annular sidewall of the liquid drain pipe.

4. A vessel according to claim 1 wherein the liquid inlet is positioned adjacent the upper surface of the tray.

5. A vessel according to claim 4 wherein the liquid inlet is formed through the annular sidewall of the liquid drain pipe.

6. A vessel according to claim 1 wherein the liquid drain pipe comprises:
an open upper end positioned above the maximum liquid level and through which the vapor inlet port is provided; and
a closed lower end positioned below the tray.

7. A vessel according to claim 1 wherein the longitudinal axis of the liquid drain pipe is substantially parallel with the longitudinal axis of the vessel shell.

8. A vessel according to claim 1 wherein the tray has an opening therein through which the liquid drain pipe extends, and wherein the vessel further comprises a circumferential seal formed between an outer circumferential surface of the liquid drain pipe and the inner circumferential surface of the tray defining the opening.

9. A vessel according to claim 8 wherein the circumferential seal comprises a circumferential weld joint.

10. A vessel according to claim 1 further comprising high and low pressure vapor zones located above and below the tray, respectively, the liquid drain pipe extending from the high pressure zone, through the tray, and to the low pressure zone.

11. A vessel according to claim 1 wherein the tray comprises a vapor-liquid distribution tray, comprising:
a tray plate through which the liquid drain pipe extends; and
a distribution unit mounted through the tray plate.

12. A vessel according to claim 11 wherein the distribution unit is included within a plurality of distribution units mounted through the tray plate, and wherein the liquid drain pipe is included within a plurality of liquid drain pipes mounted through the tray plate and interspersed with the plurality of distribution units.

13. A vessel according to claim 11 wherein the distribution unit comprises:
a downcomer pipe; and
a plurality of sidewall ports formed through the downcomer pipe at different heights with respect to the upper surface of the tray plate, the vertical distance between the lowest sidewall port included within the plurality of sidewall ports and the tray plate being less than the vertical distance between the vapor inlet and the tray plate and being greater than the vertical distance between the liquid inlet and the tray plate.

14. A vessel according to claim 1 further comprising a catalyst bed disposed within the vessel shell beneath the liquid drain pipe.

15. A method for the manufacture of a vessel including a vessel shell and a vapor-liquid distribution tray, the vapor-liquid distribution tray including a tray plate mounted within the vessel shell and over which liquid accumulates to a maximum liquid level during vessel operation, the method comprising:
providing a liquid drain pipe, comprising:
a tubular body having an upper end portion and a lower end portion;
a vapor inlet formed in the upper end portion of the tubular body;
a liquid inlet formed in the tubular body between the upper end portion and the lower end portion; and
a drainage port formed in the lower end portion of the tubular body; and
mounting the liquid drain pipe to the tray plate of the vapor-liquid distribution tray such that the vapor inlet is positioned above the maximum liquid level, the liquid inlet is positioned below the maximum liquid level and above the tray plate, and the drainage port is positioned below the upper surface of the tray plate to direct liquid accumulated above the tray plate to an area below the tray plate to drain accumulated liquid from over the vapor-liquid distribution tray during vessel shutdown.

16. A method according to claim 15 wherein the step of mounting comprises mounting the liquid drain pipe to the tray plate such that the liquid inlet is positioned adjacent the upper surface of the tray plate.

17. A method according to claim 15 wherein the vapor-liquid distribution tray further includes a plurality of distributor units mounted through tray plate, wherein the step of providing comprises providing a plurality of liquid drain pipes, and wherein the step of mounting comprises mounting the plurality of liquid drain pipes through the tray plate such that the plurality of liquid drain pipes are interspersed with the plurality of distributor units.

18. A method according to claim 15 wherein the step of mounting comprises mounting the liquid drain pipe to the tray plate such an upper portion of the tubular body extends away from tray plate in an upward direction and a lower portion of the tubular body extends from the tray plate in a downward direction.

18. A method according to claim 15 wherein the step of mounting comprises mounting the liquid drain pipe such an upper portion of the tubular body extends away from tray plate in an upward direction and a lower portion of the tubular body extends from the tray plate in a downward direction.

19. A method according to claim 15 wherein the step of providing a liquid drain pipe comprises fabricating the liquid drain pipe to include an annular sidewall having a first sidewall port to form the liquid inlet and having a second sidewall port to form the drainage port, the second sidewall port positioned below the first sidewall port.

20. A method for draining liquid from over a vapor-liquid distribution tray, the vapor-liquid distribution tray including a tray plate mounted within the vessel shell of a vessel and over which liquid accumulates to a maximum liquid level during vessel operation, the method comprising:
providing the vapor-liquid distribution tray with at least one liquid drain pipe, comprising:
a tubular body mounted to the vapor-liquid distribution tray and projecting upward therefrom;
a vapor inlet formed in the tubular body above the maximum liquid level;
a liquid inlet formed in the tubular body between the maximum liquid level and the vapor-liquid distribution tray; and
a drainage port formed in the tubular body and positioned to direct accumulated liquid above the tray to an area below the vapor-liquid distribution tray; and
directing liquid into the liquid drain pipe through the liquid inlet, through the tubular body, and out of the drainage port during vessel shutdown to drain accumulated liquid from over the vapor-liquid distribution tray.
